(19) United States
(12) Patent Application Publication
(10) Pub. No.: US 2014/0097660 A1
(43) Pub. Date: Apr. 10, 2014

(54) ANTIMICROBIAL FURNITURE AND METHOD OF MAKING

(71) Applicant: REGENCY SEATING, INC., Akron, OH (US)

(72) Inventor: John Summerville, Uniontown, OH (US)

(73) Assignee: REGENCY SEATING, INC., Akron, OH (US)

(21) Appl. No.: 13/648,529

(22) Filed: Oct. 10, 2012

(51) Int. Cl. A47C 5/12; B23P 25/00

(52) U.S. Cl. 297/452.11; 29/527.1

(57) ABSTRACT

A plastic furniture item having a base, a seat, the seat connected to the base, and a back, the back operatively connected to the seat, wherein at least the seat is made of plastic, wherein integrated with the plastic is a silver-containing antimicrobial agent, is herein disclosed.

### I. BACKGROUND

This invention generally relates to methods and compositions for furniture, and more particularly to antimicrobial furniture.

Mold, mildew, odors, staining, deterioration all cause problems with everyday items. Having built-in product protection on surfaces can combat this problem 24/7. Whether it is polymers, textiles, or non-wovens, customers now have the ability to incorporate antimicrobial protection into the products they sell. The result is true value to the customer and innovation for the product line. Silver, copper, and zinc have long been known for their antimicrobial properties and a zeolite carrier is mineral based and allows “smart” release—slow and steady when necessary.

The antimicrobial properties of silver have been known to cultures all around the world for many centuries. The Phoenicians stored water and other liquids in silver coated bottles to discourage contamination by microbes. Silver dollars used to be put into milk bottles to keep milk fresh, and water tanks of ships and airplanes that are “silvered” are able to render water potable for months. In 1884 it became a common practice to administer drops of aqueous silver nitrate to newborn's eyes to prevent the transmission of Neisseria gonorrhoeae from infected mothers to children during childbirth. In 1893, the antibacterial effectiveness of various metals was noted and this property was named the oligodynamic effect. It was later found that out of all the metals with antimicrobial properties, silver has the most effective antibacterial action and the least toxicity to animal cells. Silver became commonly used in medical treatments, such as those of wounded soldiers in World War I, to deter microbial growth. Once antibiotics were discovered, the use of silver as a bactericidal agent decreased. However, with the discovery of antibiotics came the emergence of antibiotic-resistant strains such as CA-MRSA and HA-MRSA, the flesh-eating bacteria. Due to increasing antibiotic resistance, there has recently been a renewed interest in using silver as an antibacterial agent. The availability of new laboratory technologies such as radioactive isotopes and electron microscopy has greatly enabled us to investigate the antibacterial mechanism of silver in recent years.

Although the antimicrobial properties of silver have been known for centuries, we have only recently begun to understand the mechanisms by which silver inhibits bacterial growth. It is thought that silver atoms bind to thiol groups (—SH) in enzymes and subsequently cause the deactivation of enzymes. Silver forms stable S-Ag bonds with thiol-containing compounds in the cell membrane that are involved in transmembrane energy generation and ion transport. It is also believed that silver can take part in catalytic oxidation reactions that result in the formation of disulfide bonds (R-S-S-R). Silver does this by catalyzing the reaction between oxygen molecules in the cell and hydrogen atoms of thiol groups: water is released as a product and two thiol groups become covalently bonded to one another through a disulfide bond. The silver-catalyzed formation of disulfide bonds could possibly change the shape of cellular enzymes and subsequently affect their function. The silver-catalyzed formation of disulfide bonds can lead to changes in protein structure and the inactivation of key enzymes, such as those needed for cellular respiration.

Another one of the suggested mechanisms of the antimicrobial activity of silver was proposed that Ag⁺ enters the cell and intercalates between the purine and pyrimidine base pairs disrupting the hydrogen bonding between the two anti-parallel strands and denaturing the DNA molecule. Although this has yet to be proved, it has been shown that silver ions do associate with DNA once they enter the cell. Most of the proposed mechanisms involve silver entering the cell in order to cause damage. How would a metal like silver, or its ionized form Ag⁺, get across the hydrophobic cellular membrane to access the cytoplasm? From the perspective of a transmembrane protein. the silver ion simply appears to be a particle of certain size with a +1 charge. It is possible that silver ions get access to the interior of cells through transmembrane proteins that normally function to transport ions other than silver ions. In order for silver to have any antimicrobial properties, it must be in its ionized form. Silver in its non-ionized form is inert, but contact with moisture leads to the release of silver ions. Thus, all forms of silver or silver containing compounds with observed antimicrobial properties are in one way or another sources of silver ions (Ag⁺); these silver ions may be incorporated into the substance and released slowly with time as with silver sulfadiazine, or the silver ions can come from ionizing the surface of a solid piece of silver as with silver nanoparticles.

There are two explanations as to why gram-positive bacteria are less susceptible to Ag⁺ than gram-negative bacteria. The first involves the charge of peptidoglycan molecules in the bacterial cell wall. Gram-positive bacteria have more peptidoglycan than gram-negative bacteria because of their thicker cell walls, and because peptidoglycan is negatively charged and silver ions are positively charged, more silver may get trapped by peptidoglycan in gram-positive bacteria than in gram-negative bacteria. The decreased susceptibility of gram-positive bacteria can also simply be explained by the fact that the cell wall of gram-positive bacteria is thicker than that of gram-negative bacteria.

It has also been shown that when silver treatment is combined with other antimicrobial methods such as UV light, copper ions, or oxidizers, a synergistic effect is observed, that is bacterial growth is inhibited more by treatment with silver and an additional antimicrobial method than would be expected if the inhibition effects of silver and that additional antimicrobial method were summed. Because silver can inflict a fair amount of damage to the cell only once it gains access to the cytoplasm, it is believed that if some other antimicrobial method can give silver ions access to the cytoplasm sooner than if silver ions were working alone, a synergistic effect of the two methods would be observed.

Silver can be administered to cells in a various number of ways. Silver salts such as silver nitrate (AgNO₃) are effective at providing a large quantity of silver ions all at once. Because silver binds to thiol groups, it has been proposed that although one of the antimicrobial mechanisms of Ag⁺ is binding to sulfur-containing compounds, thiol-containing compounds such as proteins with cysteine residues can also serve to absorb the silver ions and neutralize their antibacterial activity by preventing the silver ions from attacking DNA.

Silver zeolite is also a commonly used form of antibacterial silver. Zeolite is a porous matrix of sodium aluminosilicate that can bind a large amount of silver ions in its micropores. Silver ions are released from the zeolite matrix by exchange with other cations in solution and the amount released is proportional to the concentration of other cations in the solution. Minimum inhibitory concentration (MIC) assays have been performed using silver zeolite, and it was found that depending on the species tested, the minimum inhibitory concentrations of silver zeolite ranged from 256 to 2048 μg/ml, which corresponded to a range of 4.8 to 38.4 μg/ml of Ag⁺. Because zeolite is already used in some toothpastes as a polishing material and the lack of silver toxicity to humans at concentrations such as those found in the MIC assays, it was believed that silver zeolite would be a good compound to incorporate into dental materials, even those used in anaerobic conditions such as in periodontal pockets.

The increased antimicrobial activity of smaller nanoparticles could be due to the fact that smaller particles have an easier time getting through the cell membrane and cell wall and that relative to larger nanoparticles, smaller particles have a greater surface area to volume ratio. The greater surface area to volume ratio of smaller nanoparticles means that per unit mass of silver, the smaller nanoparticles have more silver atoms in contact with the solution than do larger nanoparticles. For smaller nanoparticles, this means that more of the silver atoms contained in the nanoparticle are able to take part in cell destruction processes. If only the outer layer of silver atoms of a silver nanoparticle are able to be ionized to silver ions, then a few large nanoparticles should produce less silver ions than a lot of small nanoparticles. Because silver ions are what impart antibacterial properties to a given silver-containing material, it makes sense that smaller silver nanoparticles have more antimicrobial effectiveness than larger silver nanoparticles.

The only known side effect of high exposure to or ingestion of silver is argyria, a permanent condition where silver collects in the skin and other body tissues. Long-term ingestion of gram quantities silver, most times in the form of colloidal silver, is thought to be the cause of argyria. Based on human case reports and animal experiments, 10 g of silver is thought to be the lifetime NOAEL (No Observable Adverse Effect Level). Although argyria causes a blue-gray discoloration of the skin, it is not thought to be a health risk otherwise. Depending on the degree of seriousness, argyria could be socially debilitating for some individuals. The EPA has established a secondary maximum contaminant level for silver of 0.1 mg/L. These secondary maximum contaminant levels are unenforced and are merely provided as suggestions for the management of public water systems. The reason for the non-enforcement of these secondary standards is that the contaminants for which these standards have been set all have been found to only cause aesthetic effects, which change the smell or taste of drinking water, cosmetic effects, which, as in the case of silver, are unwanted but not harmful to health, and technical effects, which may cause damage to water equipment.

Some current uses include wound dressings. Wound dressings have been developed that use silver to help prevent wound infections. Silver nanoparticles are incorporated into the wound dressing, and the silver-enhanced wound dressings were found in vitro to consistently kill Pseudomonas aeruginosa cultures entirely and kill Staphylococcus aureus cultures with >99.99% efficiency. In mice, the silver-enhanced wound dressings were also found to reduce mortality from Pseudomonas aeruginosa wound infections from 90% to 14.3%.

Another use is endotracheal tubes. Among hospital patients that require ventilator-assisted breathing, ventilator-associated pneumonia is the most common illness. Endotracheal tubes are used by patients needing ventilator-assisted breathing.

Silver coatings on the inside of endotracheal tubes have been shown to delay the appearance of bacteria on the insides of these tubes, and subjects that used the silver-coated tubes also showed decreased lung colonization by Pseudomonas aeruginosa showed that silver-coated endotracheal tubes actually do reduce the incidence or increase the onset time of ventilator-associated pneumonia in patients using a ventilator.

Another use is surgical masks. Studies have examined the antibacterial properties of surgical masks coated with silver nanoparticles. Nanoparticle coated masks were capable of a 100% reduction in viable E. coli and S. aureus cells after incubation. Additionally, the study reported no signs of skin irritation in any of the persons wearing the masks.

Another use is in cotton fibers. Silver nanoparticles have been used to impart antimicrobial activity to cotton fibers. Cotton samples were immersed in silver nanoparticle solutions and then subjected to a curing process to allow the nanoparticles to adhere to the cotton. A chemical binder was then applied to the fabric to help maintain nanoparticle-cotton binding. Cotton samples prepared in this manner were able to reduce S. aureus and E. coli cell counts by 97% and 91% respectively. Even after subjecting the fabric to 20 laundry cycles, the cotton samples were still able to reduce S. aureus and E. coli cell counts by 94% and 85% respectively. Cotton prepared in this manner could be used by individuals working in the medical field or those who often work with microbes to prevent the spread of infectious bacteria.

Another use is in drinking water. Although chlorine has long been used as the primary drinking water disinfectant, it has been shown that the chlorination of water can lead to the formation of many hazardous compounds. Based on its low known toxicity to humans, silver has been suggested as a possible disinfectant of drinking water. Water recycling systems on the Mir space station and NASA shuttles have used silver as an effective water disinfectant, and in the United States, faucet-mounted and pitcher home water purification units contain carbon filters that are supplemented with silver.

Another use is in glass. AGC Flat Glass Europe has developed a glass with antimicrobial properties. Silver ions incorporated into the glass are responsible for the antimicrobial activity. The company reports that 99.9% of bacteria that come in contact with the surface of the glass are killed. The glass was produced to help prevent the spread of pathogens in a hospital setting. It could also be used to maintain the integrity of sterile workspaces.

Another use is in food packaging. Various types of food packaging have been supplemented with silver-containing compounds to deter microbial growth and extend product shelf life. Some of these packaging types include bulk food storage containers, paperboard cartons, plastic or paper food wraps, and milk containers. Silver zeolite is the silver-containing compound used in food packaging. Although few silver-containing compounds are approved by the FDA for direct food contact, silver-incorporated food packaging is quite widespread in Japan.

### II. BRIEF DESCRIPTION OF THE DRAWINGS

At least one embodiment of the invention is set forth in the following description and is shown in the drawings and is particularly and distinctly pointed out and set forth in the appended claims.

FIG. 1 shows a three dimensional release mechanism of a multi-faceted zeolite crystal carrier;

FIG. 2 shows the ion exchange process; and,

FIG. 3 shows a perspective view of a chair.

### IV. SUMMARY

In accordance with one aspect of the invention, a plastic furniture item includes a base, a seat, the seat connected to the base, and a back, the back operatively connected to the seat, wherein at least the back or seat is made of plastic, wherein integrated with the plastic is a silver-containing antimicrobial, antifungal, and antibacterial agent.

In accordance with another aspect of the invention, the antimicrobial, antifungal, and antibacterial agent includes ammonium, silver, water, a zeolite, and zinc.

In accordance with another aspect of the invention, the agent includes 0.0% to about 2.9% by weight ammonium, about 0.3% to about 5.5% by weight silver, 0.0% to about 18.0% by weight water, about 63.0% to about 82.8% by weight zeolite, and 0.0% to about 14.4% by weight zinc.

In accordance with another aspect of the invention, the agent includes 0.0% to about 2.9% by weight ammonium, about 4.3% to about 5.5% by weight silver, about 0.3% to about 18.0% by weight water, about 63.0% to about 82.8% by weight zeolite, and about 10.5% to about 14.0% by weight zinc.

In accordance with another aspect of the invention, the agent is about 0.5% by weight of the plastic.

In accordance with another aspect of the invention, the furniture item is a chair, and the seat and the back are made of plastic containing the agent.

In accordance with another aspect of the invention, a method for manufacturing a furniture item with antimicrobial, antifungal, and antibacterial properties, wherein the furniture item has a base, a seat, and a back, includes mixing a powdered silver-based antimicrobial, antifungal, and antibacterial agent with plastic, blowmolding the seat and the back, and assembling the furniture item.

Accordingly, several objects and advantages of the present invention are providing a chair, or other furniture item that is antimicrobial, antibacterial, and antifungal. The treated furniture item provides almost a complete elimination of bacteria, fungus, and other microbes.

Other benefits and advantages will become apparent to those skilled in the art to which it pertains upon reading and understanding of the following detailed specification.

### V. DETAILED DESCRIPTION

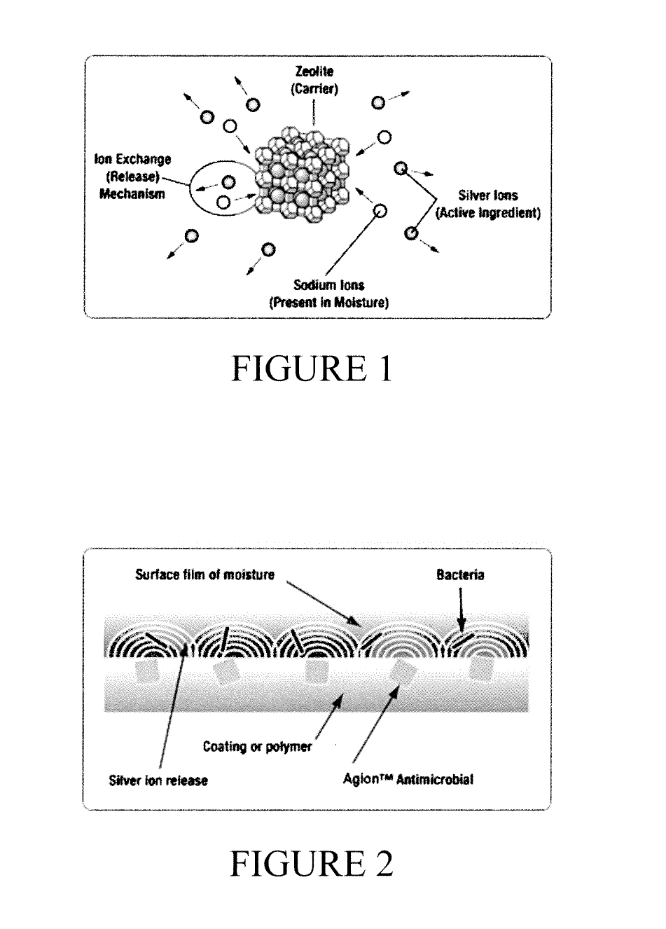

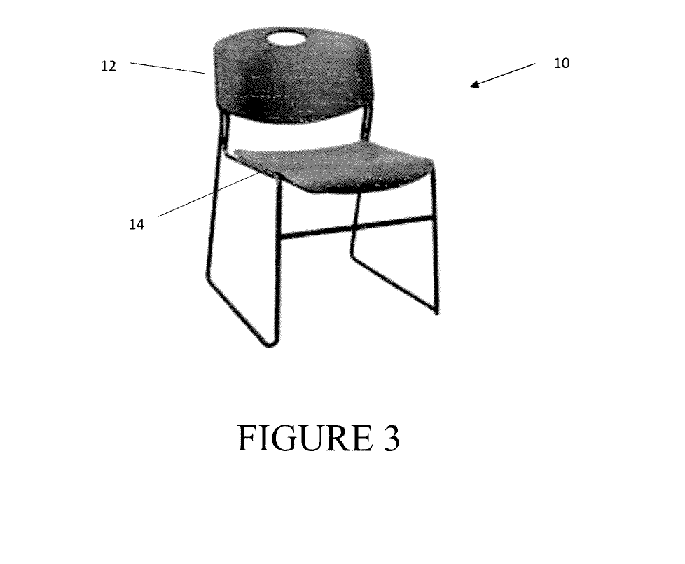

In one embodiment of the present invention. FIG. 1 shows a chair 10, having a back 12 and a seat 14. The chair 10, in this embodiment, was treated with 0.5% AK10D, a silver-containing zeolite available from AgION Technologies of Wakefield, Massachusetts. The AKIOD contains 0.0% to 2.9% by weight ammonium, 4.3% to 5.5% by weight silver, 0.3% to 18.0% by weight water, 63.0% to 82.8% zeolite, and 10.5% to 14.0% zinc. The powdered silver-containing zeolite is in a powdered form, and is mixed with plastic pellets. The mixture is heated, so that the plastic and the powder combine, and the resultant material is blowmolded into the seat 14 and back 12. The chair 10 is then assembled and ready for shipment. The chair was tested, and, after 24 hours, the treated chair backs and treated chair seats all had an organism count lower than the limits of detection of the assay. An assay control was used which at zero hours had 2.8×10⁵ organisms, and at 24 hours had 3.3×10⁶ organisms. The reduction in organisms was almost 100%.

The antimicrobial solution incorporates silver, copper, and other elemental ions into a zeolite carrier. The ions exchange with other positive ions (often sodium) from the moisture in the environment, affecting a release of the antimicrobial elements “on demand”. The multi-faceted zeolite crystal carrier provides a three dimensional release mechanism (FIG. 1) that provides efficient release of ions independent of particle orientation in the substrate.

FIG. 2 shows the ion exchange process. Zeolite crystals containing elemental ions are randomly oriented and distributed through the surface of a fiber, polymer, or coating. In conditions that support bacterial growth, positive ions, in ambient moisture, exchange with elemental ions at reversible bonding sites on the zeolite. The exchanged ions are now available to control microbial growth. Elemental ions attack multiple targets in the microbe to prevent it from growing to a destructive population. This tri-modal action fights cell growth in three ways:
1. Prevents respiration by inhibiting transport functions in the cell wall
2. Inhibits cell division (reproduction)
3. Disrupts cell metabolism

Depending on the microorganism, the antimicrobial technology has been shown to initially reduce microbial populations within minutes to hours while maintaining optimal performance for years. The antimicrobial agent inhibits the growth of bacteria, molds, fungi, and other microbes through the release of silver (Ag) ions. The controlled release of silver ions provides continuous antimicrobial protection for the product. Silver ions are released, come in contact with microbes, and the microbes are inhibited. Researchers at numerous universities and facilities have presented findings for ionic silver's antimicrobial mechanism, a simplified version of which follows: Monovalent or ionic silver (silver with a +1 charge) has an affinity for hydrogen ions, joining with them on the sulfhydryl groups present in microbes, disrupting electron transfer and respiration in bacteria and other microbes. Other non-ionic forms of silver employ other, equally effective mechanisms, such as catalyzing the interaction of atomic oxygen (O) with the sulfydryl group resulting in an OH molecule and a sulfur bond that prevents further respiration within the microbe.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof Although the description above contains much specificity, this should not be construed as limiting the scope of the invention, but as merely providing illustrations of some of the present embodiments of this invention. Various other embodiments and ramifications are possible within its scope.

Furthermore, notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Having thus described the invention, it is now claimed:

I/We claim:

1. A plastic furniture item comprising:
a base;
a seat, the seat connected to the base; and,
a back, the back operatively connected to the seat, wherein at least the back or seat is made of plastic, wherein integrated with the plastic is a silver-containing antimicrobial, antifungal, and antibacterial agent.

2. The furniture item of claim wherein the antimicrobial, antifungal, and antibacterial agent comprises:
ammonium;
silver;
water;
a zeolite; and,
zinc.

3. The furniture item of claim 2, wherein the agent comprises:
0.0% to about 2.9% by weight ammonium;
about 0.3% to about 5.5% by weight silver;
0.0% to about 18.0% by weight water;
about 63.0% to about 82.8% by weight zeolite; and,
0.0% to about 14.4% by weight zinc.

4. The furniture item of claim 2, wherein the agent comprises:
0.0% to about 2.9% by weight ammonium;
about 4.3% to about 5.5% by weight silver;
about 0.3% to about 18.0% by weight water;
about 63.0% to about 82.8% by weight zeolite; and,
about 10.5% to about 14.0% by weight zinc.

5. The furniture item of claim wherein the agent is about 0.5% by weight of the plastic.

6. The furniture item of claim 4, wherein the agent is about 0.5% by weight of the plastic.

7. The furniture item of claim 6, wherein the furniture item is a chair, and the seat and the back are made of plastic containing the agent.

8. A method for manufacturing a furniture item with antimicrobial, antifungal, and antibacterial properties, wherein the furniture item has a base, a seat, and a back, the method comprising the steps of:
mixing a powdered silver-based antimicrobial, antifungal, and antibacterial agent with plastic;
blowmolding the seat and the back; and, assembling the furniture item.

9. The method of claim 8, wherein the agent comprises:
ammonium;
silver;
water;
a zeolite; and,
zinc.

10. The method of claim 9, wherein the agent comprises:
0.0% to about 2.9% by weight ammonium;
about 0.3% to about 5.5% by weight silver;
0.0% to about 18.0% by weight water;
about 63.0% to about 82.8% by weight zeolite; and,
0.0% to about 14.4% by weight zinc.

11. The method of claim 9, wherein the agent comprises:
0.0% to about 2.9% by weight ammonium;
about 4.3% to about 5.5% by weight silver;
about 0.3% to about 18.0% by weight water;
about 63.0% to about 82.8% by weight zeolite; and,
about 10.5% to about 14.0% by weight zinc.

12. The method of claim 8, wherein the agent is about 0.5% by weight of the plastic.

13. The method of claim 11, wherein the antimicrobial agent is about 0.5% by weight of the plastic.

14. The method of claim 13, wherein the furniture item is a chair, and the seat and the back are made of plastic containing the agent.

15. A furniture item made in accordance with the method of claim 8.

16. The furniture item of claim 15, wherein the agent comprises:
ammonium;
silver;
water;
a zeolite; and,
zinc.

17. The furniture item of claim 16, wherein the agent comprises:
0.0% to about 2.9% by weight ammonium;
about 0.3% to about 5.5% by weight silver;
0.0% to about 18.0% by weight water;
about 63.0% to about 82.8% by weight zeolite; and,
0.0% to about 14.4% by weight zinc.

18. The furniture item of claim 16, wherein the agent comprises:
0.0% to about 2.9% by weight ammonium;
about 4.3% to about 5.5% by weight silver;
about 0.3% to about 18.0% by weight water;
about 63.0% to about 82.8% by weight zeolite; and,
about 10.5% to about 14.0% by weight zinc.

19. The furniture item of claim 15, wherein the agent is about 0.5% by weight of the plastic.

20. The furniture item of claim 19, wherein the furniture item is a chair, and the seat and the back are made of plastic containing the agent.
